(19) United States
(12) Patent Application Publication
(10) Pub. No.: US 2023/0100412 A1
(43) Pub. Date: Mar. 30, 2023

(54) A SYSTEM, A METHOD AND A COMPUTER PROGRAM FOR GENERATING A DIGITAL MAP OF AN ENVIRONMENT

(71) Applicant: Sony Group Corporation, Tokyo (JP)

(72) Inventors: Matthias FREY, Stuttgart (DE); Peter DÜRR, Stuttgart (DE)

(73) Assignee: Sony Group Corporation, Tokyo (JP)

(21) Appl. No.: 17/908,917

(22) PCT Filed: Mar. 2, 2021
(86) PCT No.: PCT/EP2021/055220

§ 371 Date: Sep. 2, 2022

(30) Foreign Application Priority Data
Mar. 13, 2020 (EP) 20163172.8

(51) Int. Cl. G01S 13/89; B64C 39/02; B64D 47/08; G01C 21/00; B64U 20/87

(52) U.S. Cl. CPC G01S 13/89; B64C 39/024; B64D 47/08; G01C 21/3837; G01C 21/3848; B64U 20/87; B64U 2101/30

(57) ABSTRACT

The present disclosure relates to a system for generating a digital map of an environment. The system comprises at least one sensor which is configured to record sensor data and a position of an object within the environment together with a time-stamp of recording the sensor data. Further, the system comprises a data processing circuitry configured to determine a time-dependent presence probability distribution of the object based on the sensor data. The presence probability distribution is indicative of a probability of the object being at its position before, after and/or at a time of the time-stamp. The data processing circuitry is further configured to register the presence probability distribution of the object in the digital map of an environment of the object.

### FIELD

Embodiments of the present disclosure relate to a system for generating a digital map of an environment. In particular, the embodiments relate to a concept for generating the digital map using an aerial vehicle.

### BACKGROUND

Digital maps especially play an important role in commercial and scientific sectors. For example, digital maps can be used for navigation purposes.

Established concepts provide static digital maps. In some applications a time-dependent representation and/or a prediction on a future state of an environment can be desired. Time-dependent representations or predictions, for example, may also reflect (future) structural changes of the environment, such as constructional changes of buildings or changes of a landscape. Further, they may allow a time-dependent navigation.

Document US 2019/022 098 9 A1 describes a guidance system for vehicles. The guidance system provides for a differentiation between static and dynamic objects. However, this concept does not provide predictions on a future state of the environment.

Document US 2013/009 078 7 A1 discloses a three-dimensional map system for navigation of an aircraft using a radio-altimeter, an embedded GPS/INS and a map database. This concept especially can be used to avoid collisions of the aircraft with the ground. But this concept does not provide a concept for generating a time-dependent digital map.

Hence, there may be a demand for an improved concept for digital maps.

This demand can be satisfied by the subject-matter of the appended independent and dependent claims.

### SUMMARY

According to a first aspect, the present disclosure relates to a system for generating a digital map of an environment. The system comprises at least one sensor which is configured to record sensor data and a position of an object within the environment together with a time-stamp of recording the sensor data. Further, the system comprises a data processing circuitry configured to determine a time-dependent presence probability distribution of the object based on the sensor data. The presence probability distribution is indicative of a probability of the object being at its position before, after and/or at a time of the time-stamp. The data processing circuitry is further configured to register the presence probability distribution of the object in the digital map of an environment of the object.

The environment, for example denotes an area or a space. Examples of the environment comprise public areas, landscapes or traffic areas.

Accordingly, the object can be a building, a natural structure (e.g. a tree), a vehicle (e.g. a car, a truck or a motorcycle) or people.

The sensor, for example, comprises a camera, a (time-of-flight based) three-dimensional (3D) imaging system (e.g. a stereo camera, an ultrasonic system a lidar system or a radar system) or an occupancy sensor which is capable of detecting whether the object is within the sensed environment. The sensor can be stationary installed or can be mobile. For the latter case, the sensor can be mounted to a mobile device, such as an unmanned aerial vehicle (UAV), also called “a drone”.

Hence, the sensor data can comprise (3D) image data or a three-dimensional point cloud representing the object. The sensor can comprise a clock for generating the time-stamp which indicates a time of recording the sensor data.

In some embodiments, the system can comprise multiple and/or combinations of the aforementioned sensors. This may enable the system to monitor the environment at multiple locations. Further, this can lead to an increased reliability of the sensor data.

The data processing circuitry can be a processor, a computer, a micro-controller, a field-programmable array, a graphics processing unit (GPU), a central processing unit (CPU) or any programmable hardware.

If the sensor is mounted to the mobile device, the data processing circuitry whether can be installed remote from the mobile device and the sensor or may be installed stationary. In the latter case, the data processing circuitry preferably communicates the sensor data via a wireless connection so as not to limit a freedom of movement of the mobile device as with a wired connection for a communication of the sensor data.

The data processing circuitry, for example, is able to differentiate objects from a sensed background using object recognition, as stated in more detail later.

The time-dependent probability distribution can be understood as a temporal course of the probability of the object to be at its (sensed) position within the environment. In particular, the probability distribution includes the probability of the object to be the sensed or another position within the environment before, at and after the time of a detection of the object.

The probability distribution, for example, can have a maximum at the time-stamp (time of detection) and may from then on decrease proportionally or exponentially with time and space and can depend on characteristics of the object indicating whether the object is a stationary or a mobile object and how long the object remains within the environment.

In this way, the data processing circuitry can generate a time-dependent digital map of the environment. This can be also called a “dynamic map”. In some embodiments the digital map can discard recordings of one or multiple sensed objects according to their probability distribution, for example, if the probability distribution falls short of a predefined threshold after a time. Thus, the digital map can provides a time-dependent representation of the (contemporary) environment.

### BRIEF DESCRIPTION OF THE FIGURES

Some examples of apparatuses and/or methods will be described in the following by way of example only, and with reference to the accompanying figures, in which

FIG. 1 illustrates a system for generating a digital map of an environment;

FIG. 2 illustrates a time-dependent presence probability distribution of an object being within the environment;

FIG. 3 illustrates multiple scenarios of an observation of the environment;

FIG. 4 shows a flow chart schematically illustrating a method for generating the digital map of the environment;

FIG. 5a illustrates a recording of the environment; and

FIG. 5b illustrates a determining of the presence probability distribution.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In some applications dynamic/time-dependent digital maps of an environment can be desired. Time-dependent digital maps, for example, may also reflect structural changes of the environment, such as constructional changes of buildings or changes of a landscape. Thus, time-dependent digital maps, for example, are used to represent continuously changing areas.

The present disclosure relates to a concept for generating such time-dependent digital maps.

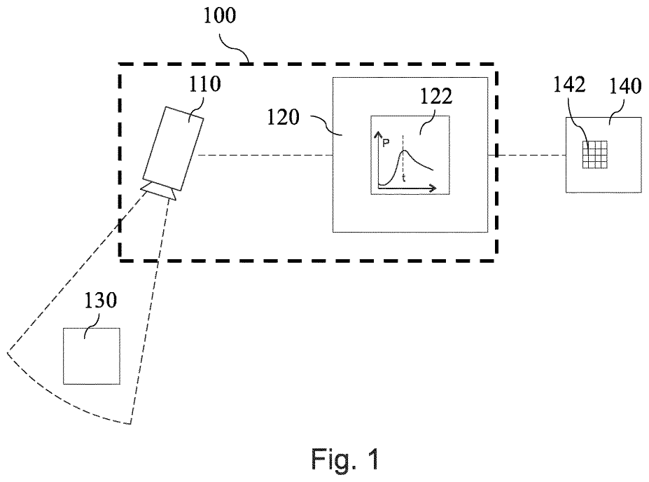

FIG. 1 illustrates a system 100 for generating a time-dependent digital map 142 of an environment.

The system 100 comprises a sensor 110 to record sensor data and a position of an object 130 together with a time-stamp of recording the sensor data.

The system 100, for example, further comprises a clock (not shown) for recording the time-stamp indicative of a time when the sensors 110 records the sensor data.

The sensor 110, for example, comprises a camera. The camera 110, for example is a RGB/color-sensitive camera, a video camera, an infrared (IR) camera or a combination thereof. Hence, the sensor data particularly can comprise image data.

In alternative embodiments, the sensor 110 can comprise a lidar system, a radar system, an ultrasonic sensor, a time-of-flight camera, an occupancy sensor or a combination thereof.

Each of the aforementioned embodiments of the sensor 110 can have a higher or lower resolution than the other embodiments under different weather conditions. Thus, the combination of multiple of the different sensors can lead to an increased reliability of the sensor data.

In the example of FIG. 1, the sensed environment corresponds to a field-of-view of the camera 110 and includes the object 130.

The data processing circuitry 120 can determine a time-dependent presence probability distribution 122 which indicates a probability that the object 130 is located at the sensed position before, after and/or at a time of the time-stamp.

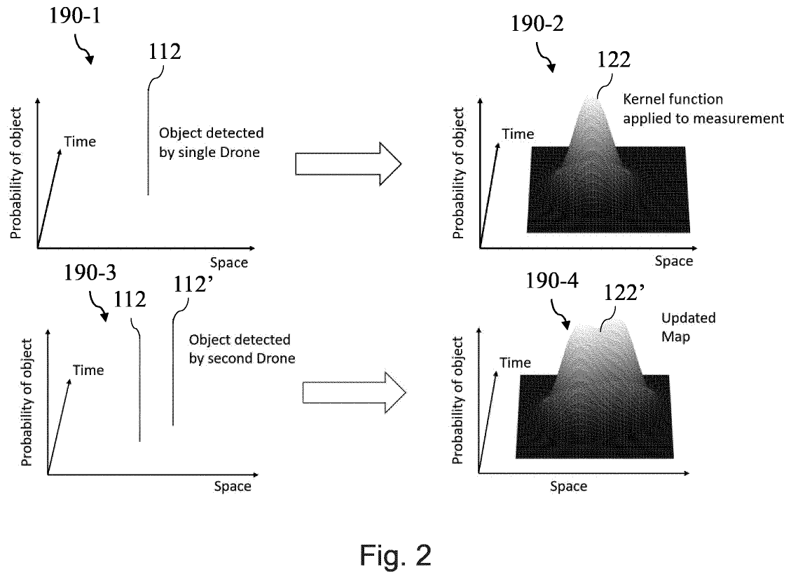

FIG. 2 illustrates an example of a generation of the presence probability distribution 122.

The data processing circuitry 120 can use object recognition for a detection and characterization of the object 130 based on the image data.

The data processing circuitry 120 can determine the position of the object 130 based on a geographical position of the camera 110 and a relative position of the object 130 to the camera 110. For this, the data processing circuitry 120, for example, determines the relative position from the image data and the geographical position of the camera 110 from position data from a global positioning system (GPS) mounted to the camera 110.

A first diagram 190-1 shows the detection 112 of the object 130 as a probability peak plotted over time and space. The detection 112, for example, is mapped to the time of the time-stamp and the object's position in the first diagram 190-1.

A second diagram 190-2 shows an example of the presence probability distribution 122.

In order to generate the presence probability distribution 122, the data processing circuitry 120 can input the position and the time-stamp into a multidimensional, and in particular a time- and space-dependent function. In the example of FIG. 2, the multidimensional function, for example, is a so-called “Gaussian kernel function”. Alternatively, the presence probability distribution 122 may correspond to alternative (multidimensional) so-called “kernel functions”.

Thus, the presence probability distribution 122 describes a probability of the object 130 to be at any point in time at any position within the environment.

As can be seen from the second diagram 190-2, the resulting presence probability distribution 122, for example, has a maximum at the time of the time-stamp and the position of the object.

Object recognition can further provide a classification of the object 130 for adjusting parameters of the presence probability distribution/Gaussian kernel function 122 in accordance with the classification of the object 130. Those parameters, for example, specify a slope and/or a full width half maximum of the Gaussian kernel function.

Object recognition, for example, can classify the object 130 as a static or a moving/mobile object. Parameters of the presence probability distribution 122 for static objects may be different from parameters of the presence probability distribution 122 for mobile objects such that the presence probability distribution 122 of static objects, for example, decrease slower than the presence probability distribution 122 of mobile objects.

The data processing circuitry 120 moreover can register the presence probability distribution 122 of the object 130 in the digital map 142 of the environment. The digital map 142, for example is a spatial map which represents the environment in a two- or three-dimensional space. Hence, the data processing circuitry 120 can register the presence probability distribution 122 in accordance with the object's position in the digital map 142.

The aforementioned system 100 thus can provide time-dependent digital maps for a time-dependent representation of the environment. This, for example, allows a time-dependent navigation in some applications of the system 100.

The system 100 further can detect the object 130 multiple times.

For the (first) detection 112, the camera 110 can record first sensor data/first image data and a first position of the object together with a first time-stamp of recording the first sensor data/first image data at a first point in time and for a second detection 112′, the camera 110 can record second sensor data/second image data and a second position of the object together with a second time-stamp of recording the second sensor data/second image data at a second point in time. For the second detection 112′, the data processing circuitry 120 can apply object recognition verify whether the object of the first and the second detection is the same.

A third diagram 190-3 shows the first detection 112 and the second detection 112′ plotted over time and space.

As can be seen in the third diagram 190-3, the object's second position determined with the second detection 112′ may be different from the first position of the first detection 112. This can be due to a motion of the object 130.

A fourth diagram 190-4 shows an updated presence probability distribution 122′ resulting from the first and the second detection 112 and 112′.

This concept, can be analogously applied on further detections of the object 130 using further sets of sensor data/image data and respective time-stamps.

The updated presence probability distribution 122′, for example, is a combination the presence probability distribution 122 and another Gaussian kernel function depending on the second time-stamp and the object's second position of the second detection 112′. Accordingly, the data processing circuitry 120 can update the digital map 142 with the updated presence probability distribution 122′. The update of the presence probability distribution 122 thus enables adjustments of the object's time- and space-dependent presence probability distribution for a more reliable and precise representation of the environment.

As can be seen in FIG. 1, the digital map 142, for example, is stored on a (physical) data storage 140 connected to the data processing circuitry 120. The data storage 140 can be a hard drive, an optical disc or the like.

The camera 110 can be mobile. This allows to extend the sensed environment beyond a field-of-view of the camera 110. For example, the camera 110 can be integrated into a mobile device, such as a vehicle, a handheld device or a wearable device.

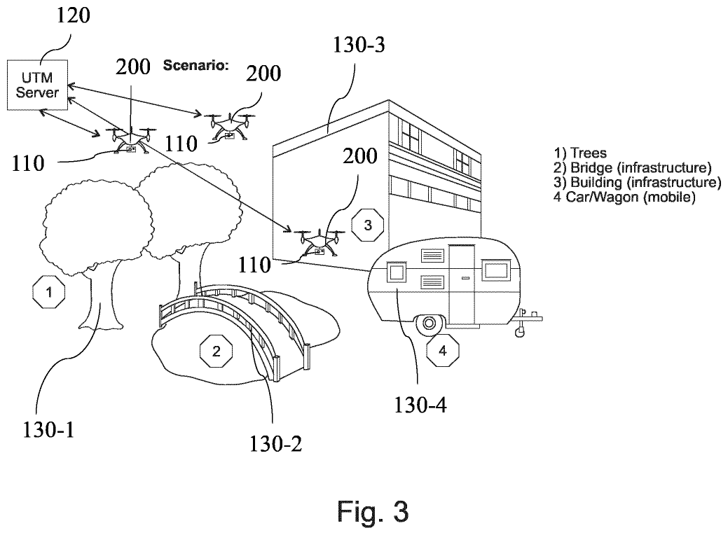

FIG. 3 illustrates multiple scenarios of an observation of the environment using the system 100.

In the shown scenarios, the camera 110 is mounted to an unmanned aerial vehicle (UAV) 200. This may enable the camera 110 to scan the environment at multiple locations from a bird's eye view. In this way, the camera 110 can detect multiple objects 130 located at the multiple locations.

In the shown scenarios, the objects 130 correspond to one or more trees 130-1 (scenario “1”), to a bridge 130-2 (scenario “2”), to a building 130-3 (scenario “3”) and/or to a trailer 130-4 (scenario “4”) each located at one of the multiple locations.

The camera 110, for example, communicates the sensor data (e.g. the image data) of the said objects 130 to the data processing circuitry 120 which in this case is a unified thread management (UTM) server.

The server 120, for example, generates and updates the digital map 142 as described by reference to FIG. 1 and FIG. 2.

Resulting from multiple detections, the system 100 can verify the classification of the trees 130-1, the bridge 130-2 and the building 130-3 as static objects and the classification of the trailer 130-4 as a mobile or moving object.

In order to avoid ambiguity errors, the server 120 further can be configured to identify the objects 130 in subsequent detections by their respective image data. Thus, the server 120, for example, can detect if one of the objects 130 has been replaced by another object.

The server 120 may further be configured to determine a structure of the objects 130 from the image data together with each detection. The structure, for example, is indicative of a contour and/or an appearance of the objects 130.

In this way, the server 120 can classify the object as a variable/changing object if the structure of the object 130 changes between the multiple detections. The trees 130-1, for example, may undergo seasonal changes. Hence, the server 120, for example, classifies the trees 130-1 as variable or changing objects.

Further, the server 120 can classify the objects 130 by their structure as “hollow” or “solid/full” using object recognition. For example, the data processing circuitry 130 can classify the bridge 130-2 as a hollow object and the building 130-3 as a solid object. This, for example, allows a more detailed representation of the environment.

The aforementioned concept further can be applied on applications using multiple UAVs 200 for surveying the environment and recording the sensor data. Those, UAVs 200, for example, can survey the environment at multiple locations at a same time which may accelerate recording the sensor data. This further enables detecting the object 130 at different points in time using different UAVs 200.

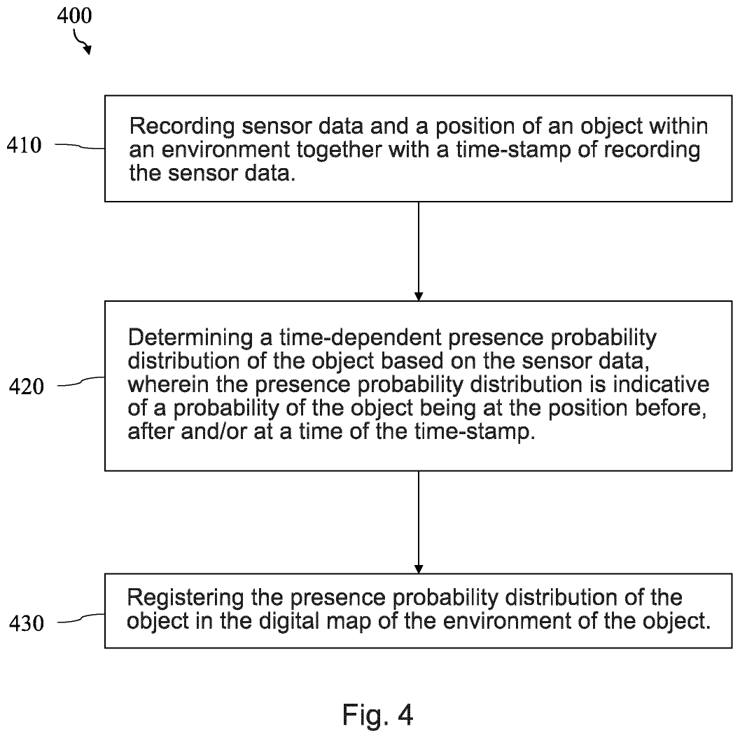

FIG. 4 shows a flow chart schematically illustrating a method 400 for generating a digital map of an environment. Method 400 comprises recording 410 sensor data and a position of an object within the environment together with a time-stamp of recording the sensor data. Further, method 400 comprises determining 420 a time-dependent presence probability distribution of the object based on the sensor data, wherein the presence probability distribution is indicative of a probability of the object being at the position before, after and/or at a time of the time-stamp. Moreover, method 400 provides for registering 430 the presence probability distribution of the object in the digital map of the environment of the object.

Using the proposed system 100, method 400 may allow to generate a time-dependent digital map 142 of the environment. Accordingly, the time-dependent digital map can enable a time-dependent representation of the environment and/or a time-dependent navigation.

More aspects and features of embodiments of method 400 are described in connection with the system 100 by reference to FIGS. 1, 2, 3 and 4.

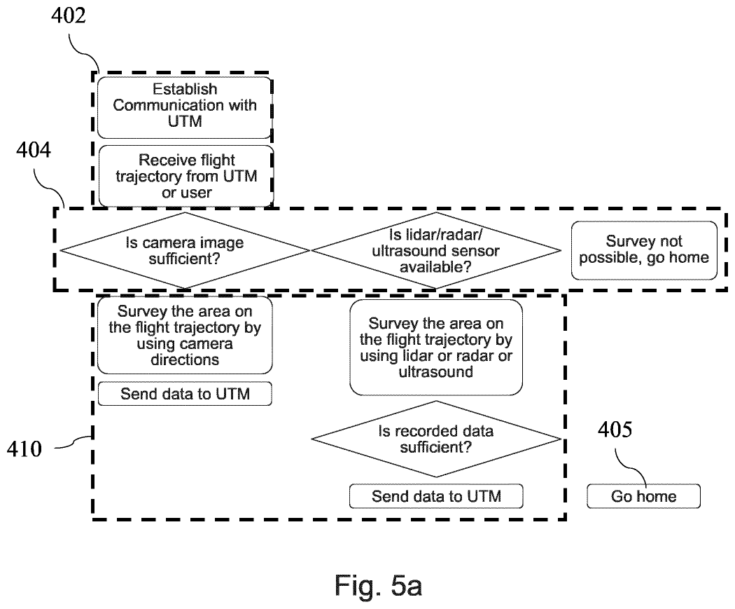

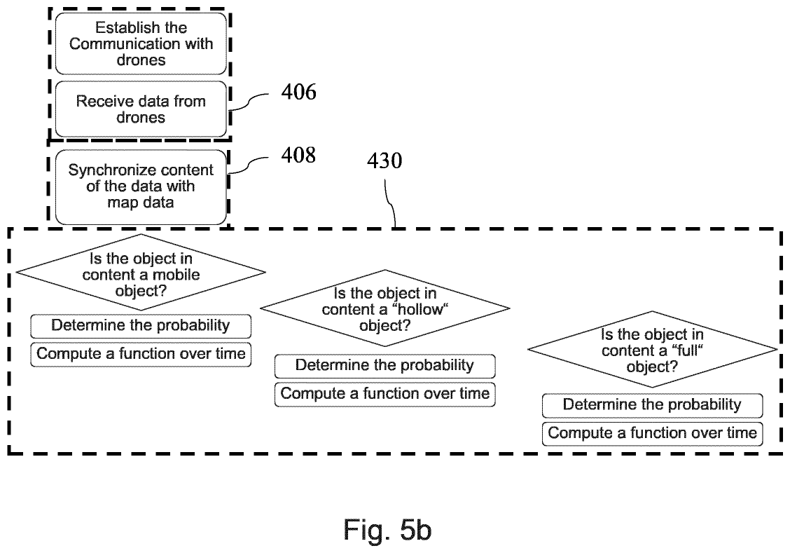

FIG. 5a and FIG. 5b illustrate the recording 410 of the sensor data and the determining 420 of the presence probability distribution 122 in more detail. FIGS. 5a and 5b particularly refer to an application of the method 400 using the UAV 200 of FIG. 3.

As can be seen from FIG. 5a, method 400 can further include a communication 402 of predetermined flight trajectories from the server 120 to the UAV 200. For this, the server 120, for example, establishes a wireless connection to the UAV 200.

Method 400 further can comprise checking 404 the availability and a contemporary accuracy of the sensor data from the camera 110, which, for example varies depending on ambient weather conditions.

If the accuracy of the sensor data from the camera 110 is sufficient, the camera 110 surveys the environment along the flight trajectory and sends the sensor data to the server 120.

If the accuracy of the sensor data from the camera 110 is not sufficient, the UAV 200 can check whether other sensors such as a lidar, a radar and/or ultrasonic sensors are available 404 and if an accuracy of the sensor data from the other sensors is sufficient. If the sensor data from the other sensors is sufficient, the UAV 200 can send those sensor data to the server 120.

In this way, the UAV 200, for example, is able to survey the environment with sufficient accuracy also in “bad weather conditions” (e.g. if it is foggy or rainy), especially if the camera 110 is not able to provide sensor data with sufficient accuracy.

As mentioned above, method 400 includes recording 410 the sensor data of the environment along the flight trajectories using the selected sensors. Additionally, method 400 can comprise checking an accuracy of the sensor data and communicating the sensor data to the server 120.

Alternatively, if none of the available sensors 110 provides a predefined sufficient accuracy, the method 400 can provide for retrieving 405 the UAV 200 back to its basis/home.

As illustrated by FIG. 5b, method 400 provides for communicating 406 the sensor data to the server 120 and synchronizing 408 the sensor data with the digital map of the environment.

For communicating 406 the sensor data, the sensors, for example, reestablish the wireless connection to the server 120.

Subsequently, the server 120 can continue with determining 430 the presence probability distribution 122 of the sensed objects 130 based on a preceding classification of the objects 130, as stated above in connection with the system 100.

As mentioned above, the server 120, for example, classifies the sensed objects 130 as “changing”, “immobile hollow” and/or “immobile solid/full” to determine their presence probability distribution 122 depending on their classification.

Consequently, the presence probability distribution 122 can be registered in the digital map 142 of the environment, for example, in form of an additional (Gaussian) kernel function.

By adding kernel functions, to the digital map, the digital map becomes dynamic and reliable also over time. Thanks to the usage of various different sensors, the system 100 can also survey the environment in “bad” weather conditions (e.g. rainfall, fog, snowfall) wherein a visibility is lower than in, for example, “good” weather conditions (e.g. sunshine).

Further embodiments pertain to:
(1) A system for generating a digital map of an environment, comprising:
   at least one sensor configured to
      record sensor data and a position of an object together with a time-stamp of recording the sensor data; and
   a data processing circuitry configured to:
      determine a time-dependent presence probability distribution of the object based on the sensor data, wherein the presence probability distribution is indicative of a probability of the object being at its position before, after and/or at a time of the time-stamp; and
      register the presence probability distribution of the object in the digital map of the environment of the object.
(2) System of (1), wherein the presence probability distribution comprises a time-dependent Gaussian kernel function depending on the time-stamp and on the position of the object.
(3) System of any one of (1) to (2),
   wherein the sensor is configured to:
      record first sensor data and a first position of the object together with a first time-stamp of recording the first sensor data at a first point in time;
      record second sensor data and a second position of the object together with a second time-stamp of recording the second sensor data at a second point in time; and
   wherein the data processing circuitry is configured to:
      determine the time-dependent presence probability distribution of the object based on the first and the second sensor data, wherein the time-dependent presence probability is indicative of the object being at the first position before, after and/or at the first point in time and being at the second position before, after and/or at the second point in time.
(4) System of (3),
   wherein the sensor is configured to record further sets of sensor data and further positions of the object together with respective time-stamps of recording the respective sets of sensor data at further points in time;
   wherein the data processing circuitry is configured to:
      determine the time-dependent presence probability distribution depending on the further sets of sensor data, the further positions, the first time-stamp, the second time-stamp, the further respective time-stamps.
(5) System of (3) or (4), wherein the data processing circuitry is configured to:
   determine a structure of the object at the first point in time from the first sensor data;
   determine the structure of the object at the second point in time from the second sensor data;
   classify the object as a variable object if the structure of the object at the first point in time differs from the structure of the object at the second point in time.
(6) System of any one of (1) to (5), comprising:
   a first sensor configured to record the first sensor data and the first position of the object together with the first time-stamp of recording the first sensor data at the first point in time; and
   a second sensor configured to record the second sensor data and the second position of the object together with the second time-stamp of recording the second sensor data at the second point in time.
(7) System of any one of (1) to (6), wherein the data processing circuitry is configured to classify the object as a moving object or as a static object based on the sensor data of the object.
(8) System of any one of (1) to (7), wherein the sensor is mounted to a mobile device.
(9) System of (8), wherein the mobile device is an unmanned aerial vehicle (UAV).
(10) System of any one of (1) to (9), wherein the sensor comprises at least one of a lidar system, an ultrasonic system, a camera, a time-of-flight camera and a radar system.
(11) Method for generating a digital map of an environment, comprising:
   recording sensor data and a position of an object together with a time-stamp of recording the sensor data; and
   determining a time-dependent presence probability distribution of the object, with which the object is within the environment, the presence probability distribution depending on the time-stamp and whether the object is within the environment; and
   registering the presence probability distribution of the object in the digital map of the environment.
(12) A computer program comprising instruction, which, when being executed by a processor, cause the processor to carry out the method of (11).

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A system for generating a digital map of an environment, comprising:
at least one sensor configured to
record sensor data and a position of an object within the environment together with a time-stamp of recording the sensor data; and
a data processing circuitry configured to:
determine a time-dependent presence probability distribution of the object based on the sensor data, wherein the presence probability distribution is indicative of a probability of the object being at the position before, after and/or at a time of the time-stamp; and
register the presence probability distribution of the object in the digital map of an environment of the object.

2. System of claim 1, wherein the presence probability distribution comprises a time-dependent Gaussian kernel function depending on the time-stamp and on the position of the object.

3. System of claim 1,
wherein the sensor is configured to:
record first sensor data and a first position of the object together with a first time-stamp of recording the first sensor data at a first point in time;
record second sensor data and a second position of the object together with a second time-stamp of recording the second sensor data at a second point in time; and
wherein the data processing circuitry is configured to:
determine the time-dependent presence probability distribution of the object based on the first and the second sensor data, wherein the time-dependent presence probability is indicative of the object being at the first position before, after and/or at the first point in time and being at the second position before, after and/or at the second point in time.

4. System of claim 3,
wherein the sensor is configured to record further sets of sensor data and further positions of the object together with respective time-stamps of recording the respective sets of sensor data at further points in time;
wherein the data processing circuitry is configured to:
determine the time-dependent presence probability distribution depending on the further sets of sensor data, the further positions, the first time-stamp, the second time-stamp, the further respective time-stamps.

5. System of claim 3, wherein the data processing circuitry is configured to:
determine a structure of the object at the first point in time from the first sensor data;
determine the structure of the object at the second point in time from the second sensor data;
classify the object as a variable object if the structure of the object at the first point in time differs from the structure of the object at the second point in time.

6. System of claim 4, comprising:
a first sensor configured to record the first sensor data and the first position of the object together with the first time-stamp of recording the first sensor data at the first point in time; and
a second sensor configured to record the second sensor data and the second position of the object together with the second time-stamp of recording the second sensor data at the second point in time.

7. System of claim 1, wherein the data processing circuitry is configured to classify the object as a moving object or as a static object based on the sensor data of the object.

8. System of claim 1, wherein the sensor is mounted to a mobile device.

9. System of claim 8, wherein the mobile device is an unmanned aerial vehicle (UAV).

10. System of claim 1, wherein the sensor comprises at least one of a lidar system, an ultrasonic system, a camera, a time-of-flight camera and a radar system.

11. Method for generating a digital map of an environment, comprising:
recording sensor data and a position of an object within the environment together with a time-stamp of recording the sensor data; and
determining a time-dependent presence probability distribution of the object based on the sensor data, wherein the presence probability distribution is indicative of a probability of the object being at the position before, after and/or at a time of the time-stamp; and
registering the presence probability distribution of the object in the digital map of the environment of the object.

12. A computer program comprising instruction, which, when being executed by a processor, cause the processor to carry out the method of claim 11.
